(19) United States
(12) Patent Application Publication
(10) Pub. No.: US 2011/0259167 A1
(43) Pub. Date: Oct. 27, 2011

(54) LASER ASSISTED POSITIONING MECHANISM

(75) Inventor: HSIN-CHIH TUNG, TAOYUAN COUNTY (TW)

(73) Assignee: LECC TECHNOLOGY CO., LTD., TAOYUAN COUNTY (TW)

(21) Appl. No.: 13/176,006

(22) Filed: Jul. 5, 2011

Related U.S. Application Data
(63) Continuation-in-part of application No. 12/591,332, filed on Nov. 17, 2009.

(51) Int. Cl. B23D 59/00

(52) U.S. Cl. 83/522.15

(57) ABSTRACT

A laser assisted positioning mechanism includes a cover, a laser module, a lens, an adjusting device and a plurality of cell holders. The cover includes a lower cover and an upper cover, and the lower cover has a hollowing supporting rib formed in a center thereof. The laser module is disposed in the cover. The lens is disposed on the lower cover of the cover in conjunction with the laser module. The adjusting device is connected with the laser module and exposed outside the upper cover. The cell holders are disposed in the cover, respectively receiving cells, and electrically connected with the laser module. Accordingly, the laser assisted positioning mechanism can be assembled and mounted on a circular saw machine and emit laser to cut materials by aligning with a desired cut line for assisting the cutting operation.

### CROSS REFERENCE TO RELATED APPLICATIONS

This application is a Continuation-in-Part of application Ser. No. 12/591,332, filed Nov. 17, 2009, now pending, and entitled LASER ASSISTED POSITIONING MECHANISM.

### BACKGROUND OF THE INVENTION

1. Field of the Invention

The present invention relates to a laser assisted positioning mechanism, and more particularly to a laser assisted positioning mechanism which can be mounted on a circular saw machine and emit laser to cut materials by aligning with a desired cut line for assisting the cutting operation, reduce its thickness for convenient installation, improve its structural strength, and provide a perfect adjustment function for a laser module.

2. Description of Related Art

Circular saw machines are mainly used in performing efficient cutting operations basing on its rapid and clean cutting characteristics. Circular saw machines are classified into manual circular saw machines in which cut materials are located and circular saws are pushed forward and machine-type circular saw machines in which circular saws are located and cut materials are pushed forward. Before cutting using the two kinds of circular saw machines, desired cut lines are marked on cut materials firstly so that blades of the circular saw machines can move along the desired cut lines. To avoid that the relative movement between the blades of the circular saw machines and the cut materials causes that kerfs depart from the desired cut lines, the circular saw machines can have laser assisted positioning mechanisms disposed thereon for aligning the blades of the circular saw machines along the desired cut lines.

A laser assisted positioning mechanism for a conventional circular saw machine includes a cover, a laser module, a power control, and supply unit fixed in the cover. The power control, supply unit, and the laser module are fixed in the cover and electrically connected with each other to drive the laser module to emit laser. The laser assisted positioning mechanism is fixed in the center of a circular saw associated with the circular saw machine, and when the circular saw works, laser diodes of the laser module emit laser, and through a lens, the laser is focused on and transmitted to a cut material to align a desired cut line for assisting the cutting operation, thereby effectively avoiding the above-mentioned condition that the relative movement between a blade of the circular saw machine and the cut material causes that kerfs depart from the desired cut line.

However, because the cover of the above-mentioned laser assisted positioning mechanism has a great thickness, the laser assisted positioning mechanism becomes larger and thicker, thereby occupying larger space. Further, since the laser assisted positioning mechanism is fixed in the center of the circular saw associated with the circular saw machine, its great thickness interferes with placement of a peripheral shield for the circular saw. In this case, the shield needs to be designed to have a convex portion, corresponding to the laser assisted positioning mechanism, so that the shield must be replaced and remounted, which is inconvenient for installation and increases costs greatly. Besides, the laser module is difficult to be positioned and adjusted, thereby increasing manufacturing costs.

Hence, the inventors of the present invention believe that the shortcomings described above are able to be improved and finally suggest the present invention which is of a reasonable design and is an effective improvement based on deep research and thought.

### SUMMARY OF THE INVENTION

A main object of the present invention is to provide a laser assisted positioning mechanism which can reduce its thickness to avoid interfering with placement of a peripheral shield for a circular saw when the laser assisted positioning mechanism is fixed in a center of the circular saw associated with a circular saw machine so that the peripheral shield is easily mounted and the costs are reduced.

Another object of the present invention is to provide a laser assisted positioning mechanism which has high structural strength to bear high pressure, ensures that a laser module can be positioned and adjusted easily, and reduces the costs.

Further, the present invention provides a laser assisted positioning mechanism having an adjusting device with an adjusting screw which is exposed outside for user to adjust the light beam conveniently and easily.

Moreover, the present invention provides a laser assisted positioning mechanism improves the actuating stability of vibration switch to stably start the laser module.

To achieve the above-mentioned object, a laser assisted positioning mechanism in accordance with the present invention is provided. The laser assisted positioning mechanism includes a cover which includes a lower cover and an upper cover, in which the lower cover has a hollowing supporting rib formed in a center thereof; a laser module disposed in the cover; a lens disposed on the lower cover of the cover in conjunction with the laser module; an adjusting device which includes an adjusting screw, two fixing screws and a fixing piece, wherein the fixing piece is pressed on the laser module, the two fixing screws respectively pass through two sides of the fixing piece and engage with the cover, and the adjusting screw engages with the fixing piece and has one end abutting against a periphery of the laser module; and a power supply unit disposed in the cover and electrically connected with the laser module.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is an exploded perspective view of first embodiment according to the present invention;

FIG. 2 is an assembled perspective view of first embodiment according to the present invention;

FIG. 3 is a cross-sectional view of first embodiment according to the present invention;

FIG. 4 is a schematic view of first embodiment according to the present invention associated with a circular saw machine;

FIG. 5 is an exploded perspective view of second embodiment according to the present invention;

FIG. 6 is another exploded perspective view of second embodiment according to the present invention;

FIG. 7 is a top view of second embodiment according to the present invention without an upper cover;

FIG. 8 is an assembled perspective view of second embodiment according to the present invention without an upper cover; and

FIG. 9 is a side view of second embodiment according to the present invention associated with a circular saw machine.

### DETAILED DESCRIPTION OF THE PREFERRED EMBODIMENTS

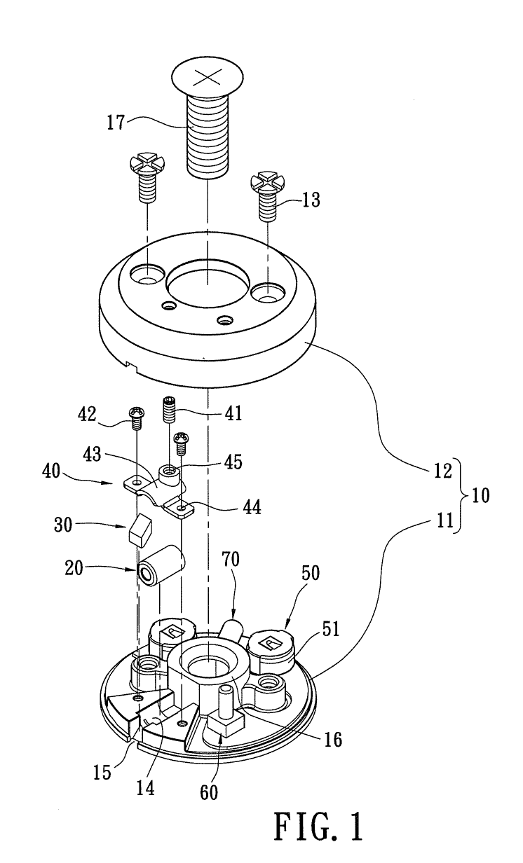

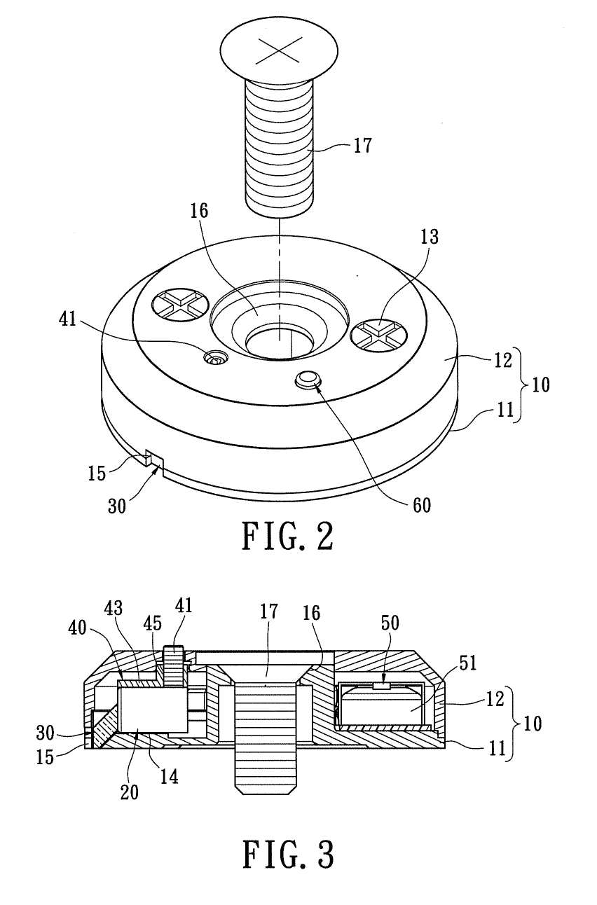

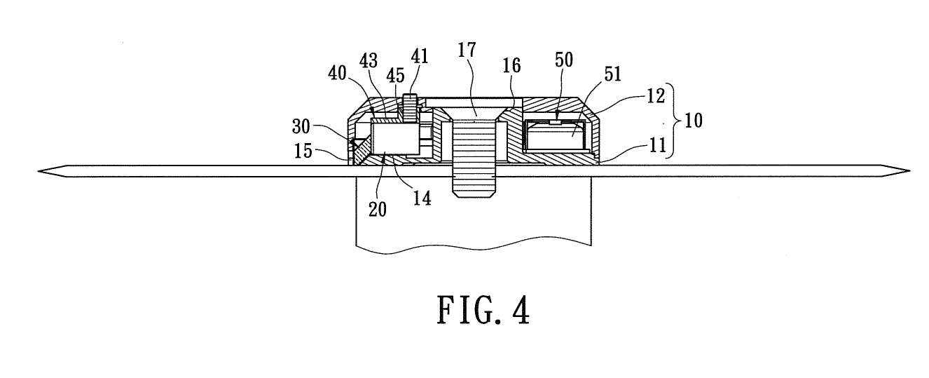

Please refer to FIG. 1, FIG. 2 and FIG. 3 illustrating a laser assisted positioning mechanism according to the present invention. The laser assisted positioning mechanism can be mounted on a circular saw machine and emit laser to a cut material by aligning a desired cut line for assisting cutting. The laser assisted positioning mechanism includes a cover 10, a laser module 20, a lens 30, an adjusting device 40, and a plurality of cell holders 50. The cover 10 includes a lower cover 11 and an upper cover 12 which are detachably locked and assembled into a unit via a plurality of fixing devices 13 such as bolts and so on. The lower cover 11 has a receiving room 14 formed therein for receiving the laser module 20. The receiving space 14 has an opening-shaped top portion and an opening-shaped end. The lower cover 11 has a through-hole 15 for receiving the lens 30, which is formed in a periphery thereof, and for connecting with the opening end of the receiving room 14. The low cover 11 has a hollow supporting rib 16 formed in the center thereof, which has an increased thickness so that a fixing bolt 17 can pass through the supporting rib 16 to engage with a circular saw machine (as shown in FIG. 4), at this time, the fixing bolt 17 can be pressed on an upper end of the supporting rib 16, so the laser assisted positioning mechanism can be located on the circular saw machine firmly.

The laser module 20 is disposed in the receiving room 14 of the cover 10 in conjunction with the through-hole 15 of the cover 15 and the lens 30, so that the laser light beam from the laser module 20 can be transmitted outwards through the lens 30. The laser module 20 is properly electrically connected with the cell holders 50 so that cells 51 of the cell holders 50 can provide electric power for the laser module 20 to drive a laser diode disposed in the laser module 20 to emit laser.

The lens 30 is a prism. The lens 30 is disposed in the through-hole 15 of the lower cover 11 and located on the lower cover 11 of the cover 10 in conjunction with the laser module 20.

In the embodiment, the adjusting device 40 includes an adjusting screw 41, two fixing screws 42 and a fixing piece 43. The fixing piece 43 is an arc-shaped sheet and is pressed on the laser module 20. The two fixing screws 42 pass through two fixing holes 44 formed in two sides of the fixing piece 43 and engage with the lower cover 11 of the cover 10. The adjusting screw 41 engages with an adjusting hole 45 of the fixing piece 43, and one end of the adjusting screw 41 abuts against the periphery of the laser module 20, adjacent to the rear end of the laser module 20, and the other end thereof extends out of the cover 10, so that the angle of the laser module 20 can be adjusted based on the rotation of the adjusting screw 41, that is, the angle of the laser from the laser module 20 can be adjusted properly.

The cell holders 50 are disposed on the lower cover 11 of the cover 10, and in the embodiment, there are two cell holders 50 disposed on the lower cover 11. The cell holders 50 and the laser module 20 are arranged on the periphery of the supporting rib 16 in the cover 10 at intervals. The cell holders 50 respectively receives the cells 51 and are electrically connected with the laser module 20 to provide power for the laser module 20, thereby establishing a power supply unit. Of course, the present invention does not limit the power supply unit in this structure, but has other types of power supply units. Furthermore, the laser module 20 can be electrically connected with a manual switch 60 and a vibration switch 70 on a circuit board 80 so as to control the laser module 20. Basing on the above-mentioned assembly, the laser assisted positioning mechanism is formed.

The laser assisted positioning mechanism can be fixed in the center of the circular saw associated with the circular saw machine (as shown in FIG. 4). When the circular saw works, the laser diode of the laser module 20 emits laser and the lens 30 can change the forward direction of the laser towards the cut material so that the laser is projected on the cut material to align with the desired cut line for assisting the cutting operation, thereby avoiding that the relative movement between the blade of the circular saw and the cut material causes that the kerfs depart from the desired cut line.

The present invention mounts the laser module 20, the lens 30 and the adjusting device 40 on the cover 10 to form the laser assisted positioning mechanism, wherein the supporting rib 16 can improve the structural strength of the cover 10, so the cover 10 can have a thin structure in design and the thickness of the cover 10 can be reduced greatly, thereby ensuring that the laser assisted positioning mechanism does not interfere with placement of a periphery shield of the circular saw when mounted and fixed in the center of the circular saw associated with the circular saw machine, so the shield needn't be replaced and remounted and can be easily installed, such that the costs are reduced.

Additionally, though the present invention has the thin structure in design, the present invention has high structural strength since the thickened supporting rib 16 is helpful to lock the fixing bolt 17 and can bear higher pressure. The laser module 20 can be positioned and adjusted easily via the adjusting device 40 formed by the adjusting screw 41, the fixing screws 42 and the fixing piece 43, thereby reducing the costs.

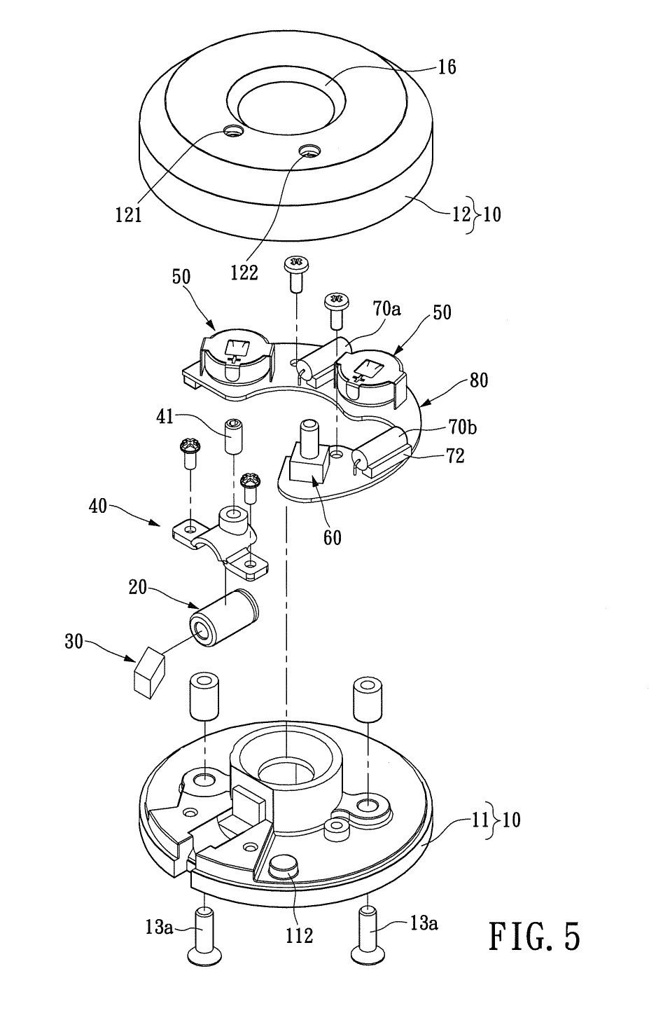

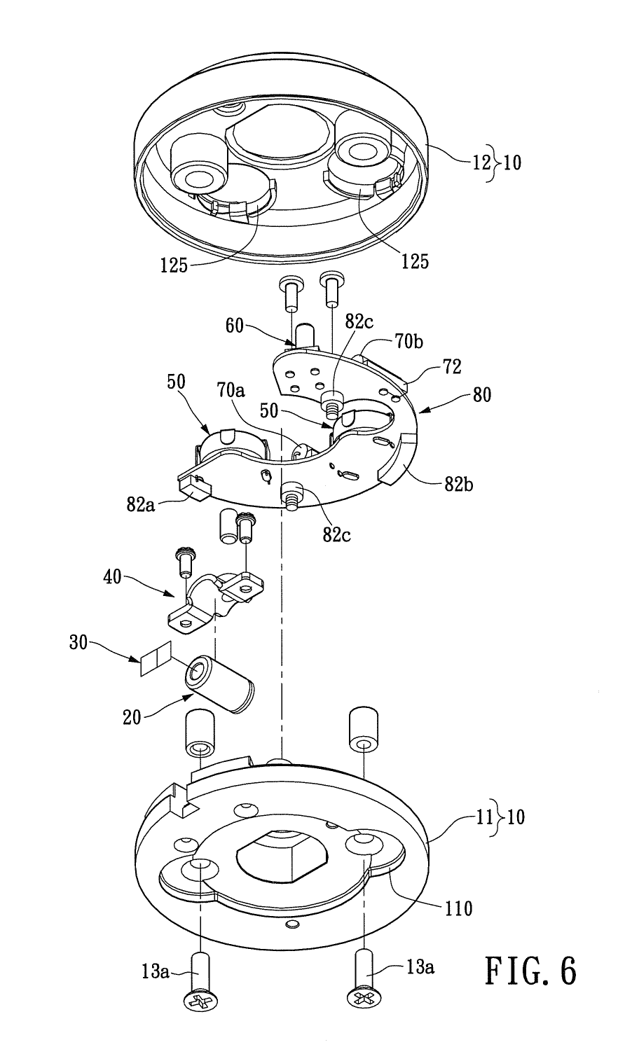

Please refer to FIGS. 5 and 6 illustrating a laser assisted positioning mechanism of second embodiment according to the present invention. In this embodiment, the laser assisted positioning mechanism provides a first vibration switch 70a and a second vibration switch 70b to more stably start the laser module 20. The first and second vibration switches 70a and 70b are electrically connected to the laser module 20 in parallel connection to alternatively switch on the laser module 20. This embodiment also provides supporting pads 72 disposed on the circuit board 80 against one side of the first and second vibration switches 70a and 70b correspondingly. In this embodiment, the pair of supporting pads 72 are used to support the vibration switches 70a and 70b to against the rotating force.

Since the present invention assembled to the circular saw machine may be disposed in many different situations and position, sometime single vibration switch could not switch on the laser module 20 immediately when the circular saw machine is turned on. In this kind machine, the vibration switch is usually actuated to complete an electrical circuit by centrifugal force or rotating force. However, the vibration switch usually is actuated when the force reaches to a predetermined amount. Thus, the vibration switch maybe not actuated, if the centrifugal force or rotating force does not match with that actuating direction of the vibration switch or not reach to a predetermined amount. For example, the circular saw machine rotates initially or approaches to a stop condition, the centrifugal force may not reach to a predetermined amount.

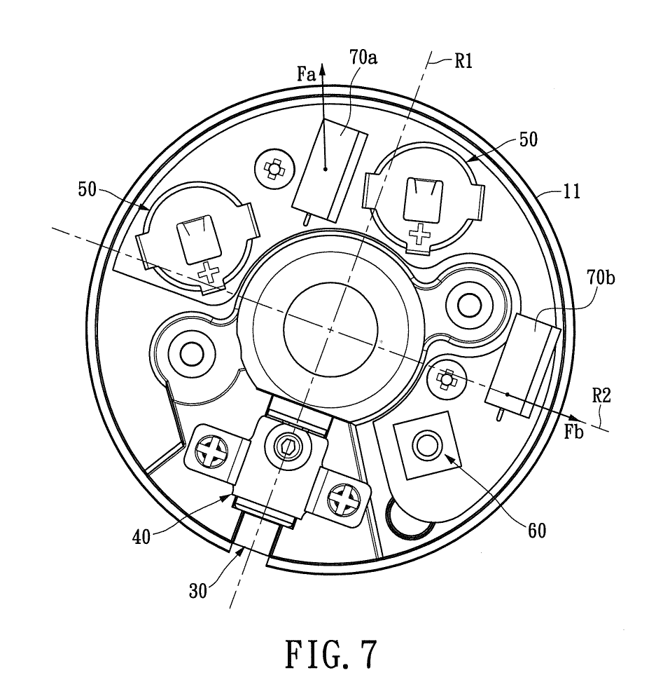

Please refer to FIG. 7. To improve the above-mentioned condition, this embodiment arranges two the first and second vibration switches 70a and 70b substantially on two diameter lines R1 and R2 of the lower cover 11. The two diameter lines R1 and R2 has an included angle substantial equal to a right angle, in other words, the diameter line R1 is substantially vertical to the diameter line R2. By this arrangement, the first and second vibration switches 70a and 70b could detect two directional centrifugal forces Fa and Fb. In other words, the laser module 20 will be switched on more immediately, especially when the circular saw machine rotates initially or approaches to a stop condition. The first and second vibration switches 70a and 70b are cooperated to switch on the laser module 20 in complementary manner.

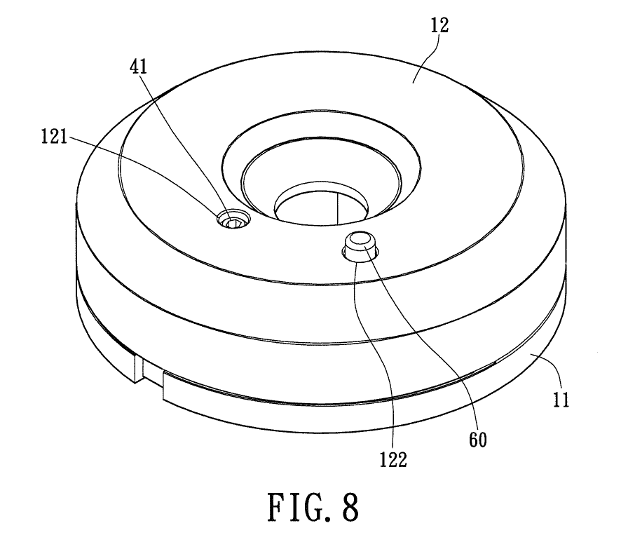

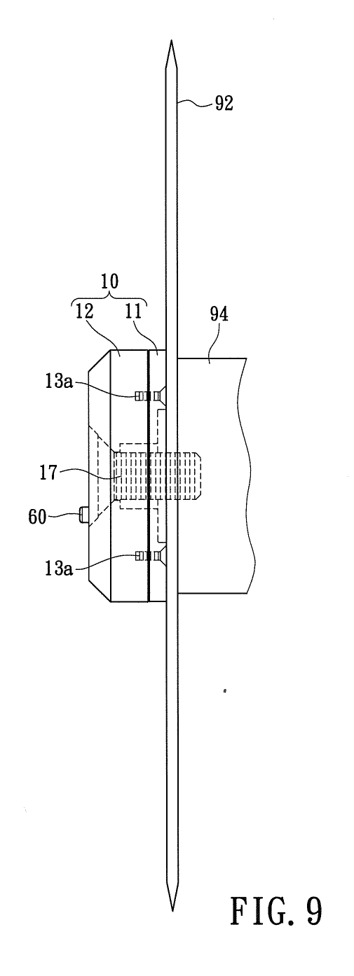

Please refer to FIG. 5. This embodiment provides two fixing device 13a, which could be screws or bolts, to fix the lower cover 11 to the upper cover 12 from a bottom side of the lower cover 11. It has advantage that the fixing device 13a can be blocked by the circular saw 92 as shown in FIG. 9. The fixing device 13a are not only be hidden, but also are more stable to avoid loosening because of vibration or rotation after an operating period. The outer appearance of the laser assisted positioning mechanism according to this embodiment is more simplified, as shown in FIG. 8, there are only the adjusting screw 41 and the manual switch 60 are exposed outside a adjusting opening 121 and a manual opening 122 on the upper cover 12.

Please refer to FIGS. 5 and 6. This embodiment has a plurality of cushion pads 82a, 82b, 82c, 112 disposed between the bottom surface of the circuit board 80 and the lower cover 11. The cushion pads 82a, 82b, 82c could absorb vibration during operating the circular saw machine. The circuit board 80 is fixed to the lower cover 11 by screws passing through the cushion pads 82c. The upper cover 12 has a pair of cell-fixing rims 125 formed on a bottom surface thereof, which cooperate with the cell holders 50 to fix the cells 51.

Consequently, the present invention can solve the problems of conventional laser assisted positioning mechanism for occupying larger space, interfering with the placement of the peripheral shield of the circular saw, and resulting in replacing and remounting the shield as conventional laser assisted positioning mechanism becomes larger and thicker. In other words, It is inconvenient for installation, and the laser module is difficult to be positioned and adjusted and has higher manufacturing costs. The present invention has utility, novelty and non-obviousness, so it meets patent requirements completely, and then is applied for patent. Please examine and grant it to guarantee inventors' rights and interests.

What are disclosed above are only the specification and the drawings of the preferred embodiment of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A laser assisted positioning mechanism, comprising:
a cover, including a lower cover and an upper cover assembled with each other, the lower cover having a hollowing supporting rib formed in a center thereof;
a laser module, disposed in the cover;
a lens, disposed on the lower cover of the cover in conjunction with the laser module;
an adjusting device, including an adjusting screw, two fixing screws and a fixing piece, wherein the fixing piece is pressed on the laser module, wherein the two fixing screws respectively pass through two sides of the fixing piece and engage with the cover, and the adjusting screw engages with the fixing piece to adjust a light beam angle of the laser module and has one end exposed outside the upper cover; and
a power supply unit, disposed in the cover and electrically connected with the laser module.

2. The laser assisted positioning mechanism as claimed in claim 1, wherein the lower cover and the upper cover are detachably locked and assembled via a plurality of fixing devices.

3. The laser assisted positioning mechanism as claimed in claim 2, wherein the fixing devices are bolts fixing the lower cover to the upper cover from a bottom side of the lower cover.

4. The laser assisted positioning mechanism as claimed in claim 1, wherein the lower cover has a receiving room formed therein, wherein the laser module is received in the receiving room.

5. The laser assisted positioning mechanism as claimed in claim 1, wherein the lens is a prism, the lower cover has a through-hole formed in a periphery thereof, and the lens is disposed in the through-hole of the lower cover.

6. The laser assisted positioning mechanism as claimed in claim 1, wherein the fixing piece is an arc-shaped sheet, and wherein the two fixing screws respectively pass through two fixing holes formed in two sides of the fixing piece and engage with the lower cover of the cover.

7. The laser assisted positioning mechanism as claimed in claim 6, wherein the adjusting screw engages with an adjusting hole of the fixing piece and the other end of the adjusting screw extends out of the cover.

8. The laser assisted positioning mechanism as claimed in claim 7, wherein the end of the adjusting screw abuts against the periphery of the laser module, adjacent to a rear end of the laser module.

9. The laser assisted positioning mechanism as claimed in claim 1, wherein the power supply unit includes at least one cell holder which receives a cell and is electrically connected with the laser module.

10. The laser assisted positioning mechanism as claimed in claim 1, wherein a fixing bolt passes through the supporting rib and engages with a circular saw machine, wherein the fixing bolt is pressed on an upper end of the supporting rib.

11. A laser assisted positioning mechanism, comprising:
a cover, including a lower cover and an upper cover assembled with each other, the lower cover having a hollowing supporting rib formed in a center thereof;
a laser module, disposed in the cover;
an adjusting device, including an adjusting screw, a fixing screw and a fixing piece, wherein the fixing piece is pressed on the laser module, the fixing screw passes through the fixing piece and engages with the cover, and the adjusting screw engages with the fixing piece to adjust a light beam angle of the laser module and has one end exposed outside the upper cover;
a first and second vibration switches, received in the lower cover and electrically connected to the laser module in parallel connection to alternatively switch on the laser module in complementary manner; and
a power supply unit, disposed in the cover and electrically connected with the laser module.

12. The laser assisted positioning mechanism as claimed in claim 11, further comprising a circuit board and a pair of supporting pads disposed on the circuit board, wherein the first and second vibration switches are disposed on the circuit board and against the pair of supporting pads correspondingly.

13. The laser assisted positioning mechanism as claimed in claim 11, wherein the first and second vibration switches are arranged substantially on two diameter lines of the lower cover, wherein the two diameter lines and has an included angle substantial equal to a right angle.

14. The laser assisted positioning mechanism as claimed in claim 12, further comprising a plurality of cushion pads disposed between the bottom surface of the circuit board and the lower cover.

15. The laser assisted positioning mechanism as claimed in claim 11, wherein the upper cover has a pair of cell-fixing rims formed on a bottom surface thereof to fix the cells.
